(19) United States
(12) Patent Application Publication
(10) Pub. No.: US 2009/0132294 A1
(43) Pub. Date: May 21, 2009

(54) METHOD FOR RANKING DRIVER'S RELATIVE RISK BASED ON REPORTED DRIVING INCIDENTS

(76) Inventor: Samuel H. Haines, Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/272,457

(22) Filed: Nov. 17, 2008

Related U.S. Application Data
(60) Provisional application No. 60/988,255, filed on Nov. 15, 2007.

(51) Int. Cl. G06Q 40/00; G01C 21/00; G06Q 50/00

(52) U.S. Cl. 705/4; 701/117

(57) ABSTRACT

The present invention relates generally to the field of improvement in the driving risk assessment arts. More particularly, but not by way of limitation, the present invention generally relates to a method of rating the driving risks of individuals based on that driver's actual driving record as obtained from his or her fellow drivers.

### CROSS REFERENCE TO RELATED APPLICATIONS

This application claims the benefit of U.S. Provisional Patent Application Ser. No. 60/988,255 filed on Nov. 15, 2007, and incorporates said provisional application by reference into this document as if fully set out at this point.

### FIELD OF THE INVENTION

The present invention relates generally to the field of improvement in the driving risk assessment arts. More particularly, but not by way of limitation, the present invention generally relates to a method of rating the driving risks of individuals based on that driver's actual driving record as obtained from his or her fellow drivers.

### BACKGROUND OF THE INVENTION

The insurance industry and companies that otherwise have an interest in driving safety (e.g., trucking companies) have long used police records of accidents, speeding tickets, etc. as a means of assessing the relative risk involved in taking on a new driver. In the case of an insurance company, a driver's safety record might be used to screen undesirable drivers from the applicant pool and/or adjust the cost of providing insurance to them according to their past driving record.

There are obvious disadvantages to relying exclusively on a police database when attempting to assess a driver's relative risk. First, it should be clear that this sort of database tends to capture only the most egregious behavior of an individual (e.g., behavior that results in a wreck or speeding ticket) and/or behavior that might be only peripherally related to driver safety (e.g., citations for parking in a loading zone). Additionally, the information in a police database also tends to underestimate the true incidence of bad driving in an individual. For example, it is likely that a driver has exceeded the speed limit many times before he or she is caught and ticketed, which ticketing would create an entry in the public database. Thus, it should be clear that current public driving records are an imperfect measure of a driver's safety.

On the other hand, the average driver likely observes many instances of poor driving during the course of his or her commute to and from work, while running errands, etc. Of course, only in extreme cases would a citizen report such behavior to the police and, as a consequence, this sort of information—as useful as it might be—goes almost entirely unreported. Thus, what is needed is a system and method that allows drivers to report on unsafe and/or illegal activities of their fellow drivers.

Heretofore, as is well known in the risk assessment industry, there has been a need for an invention to address and solve the above-described problems. Accordingly it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

According to a first preferred aspect of the instant invention, there is provided herein a system and method for compiling incidents of driver misbehavior which relies on observations that have been provided by the general public. Preferably, a phone number will be established for use by any interested driver, the purpose of which is to allow the general public to reports incidents of bad driving and/or bad behavior. If this number is dialed (or a text message is sent, etc.), the dialer will be given an opportunity to report the license tag number of the offending vehicle, together with the sort of incident that was observed (e.g., speeding, reckless driving, passing in a no-pass zone, a traffic accident, etc.). Note that in the preferred embodiment the sorts of incidents that might be reported include behaviors that might never be found in the police database.

After this information has been collected from a driver, a database search will preferably be conducted that associates the reported incident data with prior activity that has been reported in connection with the same license tag. Upon request by an insurance or other entity with the need to know such information, a numerical risk for this license tag and its associated driver will be produced.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 illustrates the general environment of the instant invention.

FIG. 2 illustrates a preferred operating logic for use with the instant invention.

### DETAILED DESCRIPTION OF THE PREFERRED EMBODIMENTS

While this invention is susceptible of being embodied in many different forms, there is shown in the drawings, and will herein be described, some specific embodiments of the instant invention. It should be understood, however, that the present disclosure is to be considered an exemplification of the principles of the invention and is not intended to limit the invention to the specific embodiments or algorithms so described.

According to a first preferred aspect of the instant invention, there is provided herein a system and method for compiling incidents of driver misbehavior which relies on observations that have been provided by the general public. Preferably, a phone number will be established for use by any interested driver, the purpose of which is to allow the general public to verbally reports incidents of bad driving and/or bad behavior. If this number is dialed (or a text message is sent, etc.), the dialer will be given an opportunity to report the license tag number of the offending vehicle, together with the sort of incident that was observed (e.g., speeding, reckless driving, passing in a no-pass zone, a traffic accident, etc.). Digital images of, for example, the license plate of the offending car might also be transmitted (e.g., from a cell phone). Note that in the preferred embodiment the sorts of incidents that might be reported include behaviors that might never be found in the police database.

One reason that a phone number will be provided is that it would be preferable to have bad driving reported contemporaneously with it occurrence. Anyone with a cell phone would, thus, be able to do this. Cell phone text messages would be acceptable, although it is preferred that verbal messages be sent for safety reasons. Thus, it is anticipated that alternative/non-verbal modes of communicating event information will be made for people who would rather send a text message or log into an Internet web page to report bad driving behaviors if they preferred to submit the information that way. Another advantage of using a cell-phone-based reporting scheme is that it would be possible in some circumstances to identify the general location of the caller and make that a part of the report. That is, having a general idea of the whereabouts of the caller could help identify typographical and other errors in the data.

The data that are received will preferably be encoded either manually or automatically (e.g., via voice recognition software) and stored in a centralized database. In the preferred embodiment, each incident report provided by the public will include at least an auto license tag number, the type of incident (e.g., speeding, reckless driving, etc.), and the date and time of the incident. If the user does not provide a date and time of the event, it is preferable that the computer system automatically provide one in the form of a date-in stamp. In some cases, the date-in stamp will be compared with a user provided date/time of the incident and the difference used as a measure of reliability of the report (e.g., when the user provided date/time is proximate to the date-in stamp the record might be deemed more reliable as being contemporaneous).

In practice, when a request comes in from, say, an insurance company regarding a prospective new customer, the instant invention will compile a mathematical score that reflects the number and type of incidents observed in connection with this individual's automobile. In one preferred embodiment, a score will be calculated generally according to the following equation:

$$Score = ⌊ {\sum }_{i = 1}^{n} S ( i , I ) ⌋ + Qfactor ( I , {DrivingRiskScore}_{h} , {R}_{h} , {C}_{h} ) ,$$

where the capital S function looks at each incident against all of the incidents for the time period being calculated and Qfactor(·) is a quality-factor-type function that takes into account the historical driving risk score (DrivingRiskScoreₕ) as well as the historical driving record (Rₕ) and historical costs to the insurance industry (Cₕ) for this automobile/driver. In the preferred embodiment, this function takes into account the historical behavior of the driver and uses it to adjust the modern incident reports to, in effect, smooth the observations. For example, in a preferred variation use of the Qfactor function will cause a driver who has historically been a very careful driver (e.g., Score near 1000) and who has a modern (e.g., over the last year or quarter) record of careless driving to see a lesser decrease in his or her Score than would a person who had a longer history of careless driving. Continuing with this example, a driver with a generally good historical driving record might see a decrease of, say, 300 in his or her driving score (say, from 1000 to 700), whereas a driver with a longer history of bad driving might see a greater decrease of, say, 400 for the same sort of activity (e.g., from 800 to 400). The Qfactor(·) function allows the instant invention to adjust the modern record in light of historical trends.

Note that the sorts of variables identified above are only generally indicative of the sorts that could be utilized. However, a preferred theme in the previous calculation is that the Score will be calculated over a variety of historical time intervals (e.g., the variable I represents reported incidents over, for example, the previous month (Iₘ), quarter (I_{q}), year (I_{y}), and five year (I₅) periods). Preferably, if any of the above variables are not available a zero will be substituted in that variable's place in the equation.

A weighted version of the above, where the different time periods are given different emphasis (e.g., the most recent observations (Iₘ) might be determined to be more significant than the five year incident report (I₅)) can readily be formulated:

$$Score = [ {\sum }_{i = 1}^{n} w ( i ) S ( i , I ) ] + Qfactor ( I , {DrivingRiskScore}_{h} , {R}_{h} , {C}_{h} )$$

where w(i) is a weighting function (preferably with the sums of the weights being equal to unity). Those of ordinary skill in the art will recognize how such weight functions are chosen and applied to emphasize or deemphasize various variables in the summation.

Turning now to a more detailed discussion of the previous scoring function, let I be the set of all driving incidents for a given tag/driver:

I={all incidents}={i₁, i₂, . . . iₙ}

Preferably, the set of all incidents will be further differentiated as follows: I′=Unique(I), where Unique(I) reduces the set of incidents for this driver/tag by eliminating events that are reported by the same phone within a predetermined safety period.

I″=Defraud(I′),

where the I′ incidents are further reduced by eliminating reports that are determined to be suspect or fraudulent for this driver/tag.

Iₘ=MonthlyIncidents(I″).

That is, the I″ incidents are queried to determine how many were noted within the past month.

I_{q}=QuarterlyIncidents(I″),

I_{y}=YearlyIncidents(I″), and,

I₅=FiveYearIncidents(I″).

These groupings count the quarterly, yearly, and five-year incident counts for this driver.

In a preferred embodiment, a driving risk score will be calculated by using the previous four time periods. This calculation will utilize the relative risk for each period to obtain a composite (preferably averaged) risk score. In the preferred embodiment, the risk score will be calculated as follows:

S=DrivingRiskScore(Iₘ, I_{q}, I_{y}, I₅)

where, the DrivingRiskScore is preferably calculated as the average of the individual scores. That is,

DrivingRiskScore=(Score(Iₘ)+Score(I_{q})+Score(I_{y})+Score(I₅))/4

where each Score(·) is preferably bounded between zero and, say, 1,000 (i.e., 0≦Score(·)≦1,000). The score function Score(·) might be as simple as a raw sum of the incident counts (or a time-average of them, etc.) or it might be more complex with different weights being assigned to each sort of incident measurement (e.g., the score associated with the monthly incident count, Iₘ, might be given greater weight than, say, the annual or five year count, etc.). Those of ordinary skill in the art will understand how a weight function might be constructed and applied to the various sorts of incident parameters mentioned previously.

It should be noted that a goal of the instant scoring function is to provide a single value that represents in some way the composite driving record of an individual and, thus, a single valued risk associated with this driver. As is indicated above, this score might be a sum or some other functional combination (e.g., geometric mean, median, etc.) of the incident data stored in the database. That being said, those of ordinary skill in the art will recognize that it is certainly possible that multiple risk values might be provided to a requestor (e.g., the risk over the previous year, the risk over the previous six months, etc.).

For purposes of mathematical convenience, in some embodiments each incidence variable (i.e., Iₘ, I_{q}, etc.) will be weighted by a predetermined constant (or weighting) multiplier. Preferably, the multiplier will be at least initially equal to 50 (an arbitrary value), although that value could change over time as the instant method evolves through addition of data to the database. This will preferably result in a driver score will be scaled to be between 0 and 1,000, with 0 being maximally bad and 1000 being a perfect driver.

In other cases, the weight function might be variable. For example, in some preferred embodiments the multiplier will be chosen instead to be a function such as:

Multiplier(I)=1+StandardDeviation(I),

where the StandardDeviation(I) might be calculated based on that particular driver's history or based on some estimate of the population standard deviation. As a consequence, in some embodiments the driver's score will be calculated as follows:

$$Score = {\sum }_{i = 1}^{n} 50 * StandardDeviation ( i , I ) + 0.$$

As a specific example, consider a case where the previous equation, consider a case where two measures are used in the summation (e.g., Iₘ and I_{q}), where each variable has a value of 2.5, and where the multiplier is chosen to be equal to 50. In that case:

$$\begin{matrix}Score = {\sum }_{i = 1}^{2} 50 * StandardDeviation ( i , I ) \\ = [ 50 * 2.5 ] + [ 50 * 2.5 ] \\ = 250\end{matrix}$$

Then, and preferably, the DrivingRiskScoreh will be calculated according to a formula given below for purposes of illustration:

$$\begin{matrix}{DrivingRiskScore}_{h} = [ 1000 - Score ] \\ = ( 1000 - 250 ) \\ = 750\end{matrix}$$

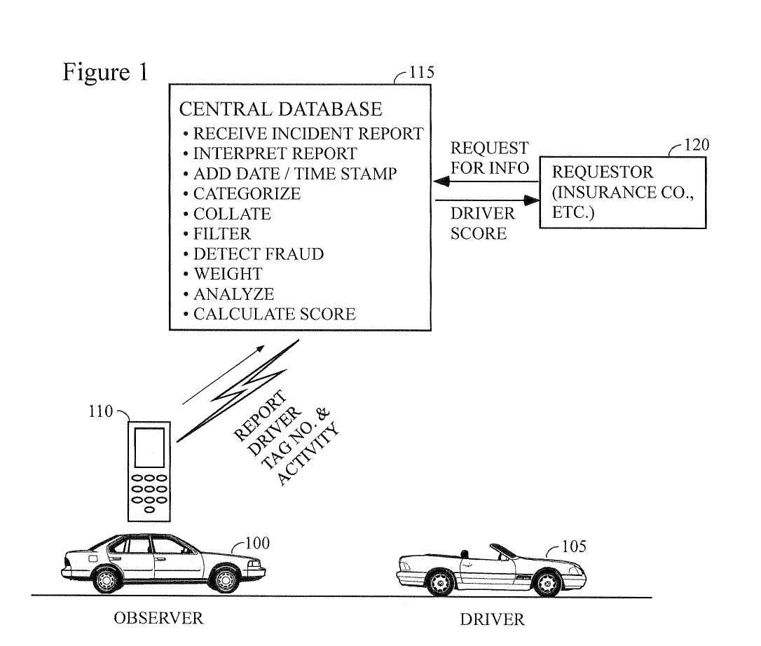

Turning next to a discussion of the figures, FIG. 1 provides a schematic illustration of a preferred embodiment of the instant invention. In the preferred arrangement, a driver in vehicle 100 will observe a reportable incident committed by the driver in car 105. The driver in the reporting vehicle 100 will preferably place a call via cell phone 110 to a centralized facility 115 to report the observation.

Preferably the driver in car 100 will be asked to verbally report at least the license plate number of the auto 105 as well as sort of infraction that was observed (e.g., tailgating, running a stop sign, double parking, hit-and-run, speeding, etc.).

Additional information that might be useful (if the observer in car 105 knows it) would include the make and model of car 105, the approximate location of the incident, the time of the incident (especially if it is being reported after the fact), a physical description of the driver in car 105 (perhaps limited to male/female, or ethnicity). Even very generalized information about the auto 105 (e.g., color, manufacturer) or its driver might be used for purposes of quality control in the steps that follow. Finally, in some preferred embodiments the user might be asked (e.g., on a scale from 1 to 5) to rate how “certain” he or she is of the information that had just been reported, with the numerical value being used to weight individual incident reports according to methods well known to those of ordinary skill in the art. Those of ordinary skill in the art will recognize that many other sorts of information might be collected from the observer and used according to the instant invention.

Although the preferred embodiment utilizes a cell phone, those of ordinary skill in the art will readily understand that after-the-fact information could certainly be transmitted by an observer. For example, the observer might wait until he or she was at home to make a phone call. Similarly, the observer might prefer to log onto a web site and enter the requisite information there (e.g., perhaps to preserve anonymity). In still other preferred embodiments, the observer (who may or may not be the driver of vehicle 100) will access the central computer 115 via the Internet contemporaneously with the incident (e.g., via a smart phone or laptop with a wireless connection, etc.). Those of ordinary skill in the art will recognize that there are many ways that observers might provide data for use by the instant invention.

However the data are acquired, as a next preferred step the information provided for the incident will be received and interpreted (e.g., if the user has provided the information verbally it will need to be converted to a computer readable format) and a time and date stamp will be added.

Next, and preferably, the data will be categorized as to type of incident and collated with other incidents that have been reported for the same tag number.

A quality control step will preferably be performed next. In the preferred arrangement, each incident report will be filtered or otherwise processed to detect possible errors. For example, license plate numbers that are incomplete or obviously erroneous (e.g., where a number is reported in a field that could only be a character) will preferably be identified at this step. Obviously, a mistake in the reporting of the automobile tag would be problematic for the instant invention. However, in some instances it may be possible to correct this sort of error and save the observation by cross-reference to other reports of the same incident. Additionally, if information that has been provided about the subject vehicle (e/g., make, model, color, etc.) or driver (gender, ethnicity, etc.) that information will preferably be compared with official information regarding that tag number and record owner. Obviously, mistakes in any of the foregoing are possible so it is expected that in some cases this sort of information will need to be disregarded.

Next, and preferably, some sort of attempt will be made to detect fraudulent data items. For example, the report might be suspected to be fraudulent if the observer reports the same incident several times, if the observer reports an incident that because of its time of occurrence or place cannot be an offense (e.g., speeding in a school zone when school is not in session), etc.

Then, upon receipt of a request from an insurance company 120 or other organization with a need to assess the driver's risk, the instant invention will weight, analyze, and provide a summary score (or scores) to the requester. Note that in some cases the driver may have multiple vehicles registered in his or her name. In such a case, a single/composite score that is based on incidents for all cars might be returned, or, if the requester desires it, as many different scores as there are autos registered could be provided, etc.

A goal with respect to the instant calculation is to obtain a score that is based on the reporting patterns of all of the incidents being reported. Preferably, the resulting value will be scaled to be between 0 and 1,000, with 0 being maximally bad and 1000 being a perfect driver.

Needless to say, systems that rely on data that have been contributed by the public are subject to abuse in a number of ways. As a consequence, it is anticipated that some effort will be made to identify fraudulent incident reports (if possible) and eliminated or down weight them before calculating a risk score. Thus, it should be assumed that the data used in the previous calculation have been edited to the extent possible. As one example of the sort of screening/editing that might be performed, if the same individual contributed multiple reports of the same incident, that incident might be considered to be suspect. Such observations might be given reduced or no weight in the score calculation. Additionally, since identification of the contributor might be obtained from his or her telephone number (if the dial-in route is used) or via information related to the contributor's ISP (or other computer-related information) if the report came via the Internet, information about the reporting party might be used to filter or reduce the weight of event reports received from that source. Reports that originate from a user with a history of multiple submissions in connection with a single event could be deemphasized or even eliminated.

Additionally, non-unique observations (e.g., where multiple persons report the same incident) may be eliminated, although a record will likely be kept of same and could be useful in some instances (e.g., as a measure of observer reliability)

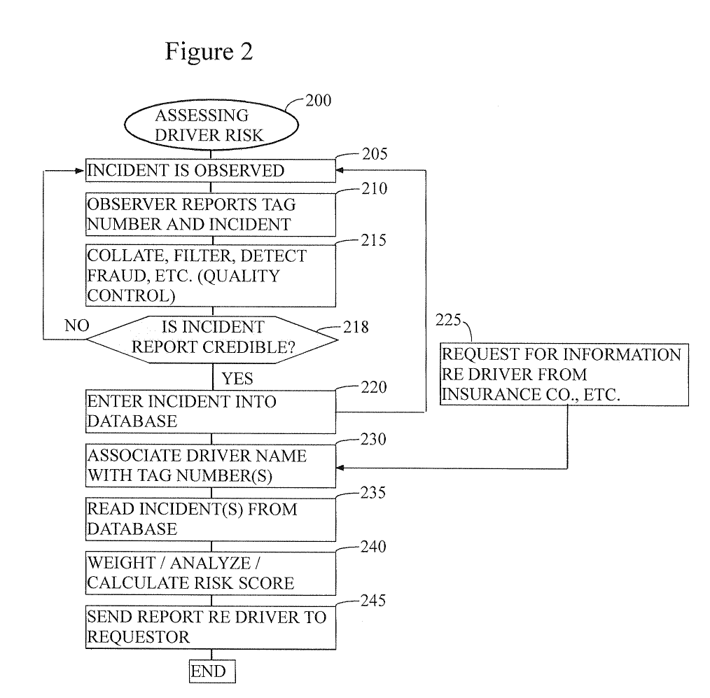

Finally, and turning now to FIG. 2, in a preferred arrangement the instant method 200 begins by acquiring incident reports from drivers or other observers (step 205). Preferably, and as has been discussed previously, the observer will report at least the tag number of the offending vehicle and the type of incident (step 210). Next, at step 215 the user-provided information will be collated, filtered, etc. as has been discussed previously. If the information is determined to be unreliable, it will preferably not be stored in the database (i.e., the “NO” branch of decision item 218) or, in some cases, it would be stored in the database along with an indication that this observation is suspect. Otherwise, if the incident report appears credible, it will be stored in the database (step 220). Obviously, the instant process of acquiring, filtering, and storing data might continue indefinitely (loop 220 to 205).

At some point it is anticipated a requester will ask for information re a specific driver (step 225) or, in some instances, a specific automobile. Note that this information might take the form of the driver's name and, for example, his or her driver's license number. In other preferred embodiments, the requestor might provide a license tag number for a vehicle. Those of ordinary skill in the art will readily be able to devise alternative sorts of queries suitable for use with the instant invention.

As a next preferred step 230, the instant invention will preferably associate the driver for whom information has been requested with a license tag number or other identifying characteristic of the vehicle. Obviously, in those instances where the requester has provided a tag number, this step will not be necessary. Otherwise, state tag databases could be used to link a driver with a vehicle.

Next, and preferably, the instant invention will read the associated incident reports (if any) from the database (step 235) and calculate a risk score (or scores) according to the methods discussed previously (step 240). Obviously, if there are no incident reports for a given driver or tag number, the assumption would be that that driver has a clean record. However, those of ordinary skill in the art will recognize that the absence of such incidents could simply be because none have been observed and reported to date. Thus, a perfect score would be indicative—but not determinative—of a good driver.

Finally, the instant invention will preferably transmit a report, which will include at least an overall risk score, back to the requester (step 245). Additionally, more detailed information might be provided such as the actual incident reports or a summary of same.

The requestor will preferably be an insurance company, with the risk score being used to approve/deny coverage and set rates. The instant information might also be used by companies who wish to hire a truck or other driver, school systems who wish to hire bus drivers, etc. In brief, the requester might be any entity that is basing a hiring or other decision in whole or in part on a driver's incident record.

Those of ordinary skill in the art will recognize that the invent method is suitable for use with vehicles (including without limitation, autos, semis, 18 wheelers, etc.), it certainly could be used in other transportation related contexts (e.g., boats, planes, etc.).

The term “database” as has been used herein should be broadly construed to include any organized collection of information including hierarchical databases, relational databases, keyed files, as well as flat/sequentially accessed files (e.g., spread sheets, text files, etc.). Further, it should be noted and remembered that a database that is usable by the instant invention might be stored as a single file on a single computer, as a single file on multiple computers, as multiple files on one or more computers, etc.

Note that, for purposes of the claims that follow, the term “performing quality control” on an incoming incident report should be broadly construed to include filtering (e.g., to exclude multiple reports from the same source regarding the same or a different incident), fraud detection. In brief, quality control should be understood

Finally, it is contemplated that implementation of the instant invention would require publication of the central reporting phone number, web site URL etc., to make the public aware of the service and instruct them as to how to participate. Given the impact on public safety that such a method could have, support for the educational/awareness program from the state and/or federal government and/or the insurance industry might be expected.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those skilled in the art, without departing from the spirit of the inventive concept the scope of which is to be determined by the following claims.

What is claimed is:

1. A method of establishing a risk associated with a driver, comprising the steps of:
a. observing a driving incident involving a subject vehicle;
b. transmitting a communication representative of said driving incident to a central database, said communication at least including a representation of said driving incident and at least one subject vehicle identifying characteristic;
c. receiving in said central database said communication representation of said driving incident;
d. storing data representative of said communication in a database on a computer readable medium;
e. performing steps (a) through (d) until at least two different subject vehicles have been observed and until a plurality of said data representative of said communication have been stored in said database;
f. receiving a request for information concerning a driver from a requester;
g. associating the driver with at least one driver vehicle identifying characteristic;
h. using at least one of said at least one driver vehicle identifying characteristic to read at least one data representative of said communication from said database;
i. using any of said read data representative of said communication to formulate a risk score for the driver;
j. transmitting said risk score to said requester; and,
k. taking an action with respect to the driver based on said risk score.

2. The method of establishing a risk associated with a driver according to claim 1, wherein said requester is an insurance company and step (k) comprises the steps of:
(k1) using at least said risk score to establish an auto insurance rate for the driver, and,
(k2) obtaining a payment from the driver equal to said auto insurance rate.

3. The method of establishing a risk associated with a driver according to claim 1, wherein said at least one subject vehicle identifying characteristic is chosen from a group consisting of an automobile tag number, a vehicle make, a vehicle model, a vehicle color, and a driver description.

4. The method of establishing a risk associated with a driver according to claim 1, wherein step (d) comprises the steps of:
(d1) performing a quality control procedure on communication representative of said driving incident,
(d2) if said quality control procedure indicates said communication representative of said driving incident is credible, storing data representative of said communication in a database on a computer readable medium, and,
(d3) if said quality control procedure indicates said communication representative of said driving incident is not credible, taking no action with respect to said communication representative of said driving incident.

5. The method of establishing a risk associated with a driver according to claim 1, wherein said driving incident is chosen from a group consisting of a tailgating incident, a double parking incident, a hit-and-run incident, a speeding incident, a reckless driving incident, and an incident where a stop sign is run.

6. The method of establishing a risk associated with a driver according to claim 1, wherein said stored data representative of said communication comprises at least a date of said driving incident, an approximate location of said driving incident, and a type of said driving incident.

7. A method of establishing a risk associated with a requester vehicle, comprising the steps of:
a. obtaining a description of a driving incident, said description at least including a representation of said driving incident and at least one subject vehicle identifying characteristic;
b. storing a plurality of information items representative of said description in a computer readable database;
c. performing steps (a) and (b) until information items representative of at least two different driving incidents are stored in said computer readable database;
d. receiving a request for information concerning said requester vehicle from a requester;
e. determining at least one identifying parameter of said requestor vehicle;
f. using at least one of said at least one identifying parameter to identify said requester vehicle within said database;
g. reading from said data base any incident data associated with said requester vehicle;
h. using at least a portion of said read incident data to formulate a risk score for the driver;
i. transmitting said risk score to said requester; and,
j. taking an action with respect to said requester vehicle based on said risk score.

8. The method of establishing a risk associated with a requester vehicle according to claim 7, wherein said requester is an insurance company and step (k) comprises the steps of:
(k1) using at least said risk score to establish an auto insurance rate for said requestor vehicle, and,
(k2) obtaining a payment equal to said auto insurance rate.

9. The method of establishing a risk associated with a requester vehicle according to claim 7, wherein said at least one subject vehicle identifying characteristic is chosen from a group consisting of an automobile tag number, a vehicle make, a vehicle model, a vehicle color, and a driver description.

10. The method of establishing a risk associated with a requester vehicle according to claim 1, wherein step (b) comprises the steps of:
(b1) identifying a plurality of information items representative of said description,
(b2) performing a quality control procedure on said plurality of information items representative of said description,
(b3) if said quality control procedure indicates said description is credible, storing said data representative of said description in a computer readable database, and,
(b4) if said quality control procedure indicates said description is not credible, taking no action with respect to said description.

11. The method of establishing a risk associated with a requester vehicle according to claim 7, wherein said driving incident is chosen from a group consisting of a tailgating incident, a double parking incident, a hit-and-run incident, a speeding incident, a reckless driving incident, and an incident where a stop sign is run.

12. The method of establishing a risk associated with a requester vehicle according to claim 1, wherein said plurality of data items comprises at least a date of said driving incident, an approximate location of said driving incident, and a type of said driving incident.
